(19) United States
(12) Patent Application Publication
(10) Pub. No.: US 2026/0132313 A1
(43) Pub. Date: May 14, 2026

(54) COMPOSITION AND FILM

(71) Applicant: FUJIFILM Corporation, Tokyo (JP)

(72) Inventors: Haruki TOMIKAWA, Kanagawa (JP); Toshihide YOSHITANI, Kanagawa (JP); Ren ISHIKAWA, Kanagawa (JP)

(73) Assignee: FUJIFILM Corporation, Tokyo (JP)

(21) Appl. No.: 19/445,667

(22) Filed: Jan. 12, 2026

Related U.S. Application Data
(63) Continuation of application No. PCT/JP2024/026146, filed on Jul. 22, 2024.

(30) Foreign Application Priority Data
Jul. 27, 2023 (JP) 2023-122625

(51) Int. Cl. C09J 7/29

(52) U.S. Cl. CPC C09J 7/29; C09J 2475/006

(57) ABSTRACT

A first object of the present invention is to provide a composition that is excellent in water stopping ability, embedding property, and maintainability of an embedded state. In addition, a second object of the present invention is to provide a film formed of the above-mentioned composition.

The composition of the present invention is a composition including a polyurethane formed from a polyol containing a polyoxyalkylene structure and a polyisocyanate; and
particles,
in which the composition has an Asker C hardness of 5 or less,
a ratio of a loss elastic modulus G″ to a storage elastic modulus G′ at a temperature of 25° C., a frequency of 1 Hz, and a strain of 0.1% of 0.400 or more, and
a ratio of the storage elastic modulus G′ at a temperature of 25° C., a frequency of 1 Hz, and a strain of 10% to the storage elastic modulus G′ at a temperature of 25° C., a frequency of 1 Hz, and a strain of 0.1% of less than 0.900.

### CROSS-REFERENCE TO RELATED APPLICATIONS

This application is a Continuation of PCT International Application No. PCT/JP2024/026146 filed on Jul. 22, 2024, which claims priority under 35 U.S.C. § 119 (a) to Japanese Patent Application No. 2023-122625 filed on Jul. 27, 2023. The above applications are hereby expressly incorporated by reference, in their entirety, into the present application.

### BACKGROUND OF THE INVENTION

### 1. Field of the Invention

The present invention relates to a composition and a film.

### 2. Description of the Related Art

In order to mitigate damage caused by flooding or water leakage, various water stopping techniques have been studied.

Examples of the water stopping technique include a method of covering a water inlet or outlet with a water stopping material. The flooding damage to buildings occurs, for example, due to the inflow of water from gaps present in windows, doors, and the like. A method of sealing a gap with a water stopping material to suppress the intrusion of water is effective against such flooding damage.

Specifically, for example, a water stopping material formed of a water absorbent composition, which absorbs water and stops water in a case where water comes into contact with the water absorbent composition placed in the path of water intrusion, has been studied.

As the water stopping material as described above, for example, JP1988-036341A (JP-S63-036341A) discloses a water stopping material consisting of a closed-cell flexible polyurethane foam body having a closed cell ratio of 15% or more, in which a water absorbent resin is contained, and having a hardness of 70 or less as measured with an Asker C-type hardness meter after pressurization for 5 minutes.

### SUMMARY OF THE INVENTION

In recent years, there has been an increasing demand for a water stopping material that can be easily used in locations of various shapes, and a composition used in such a water stopping material is required to have excellent water stopping ability and embedding property. In the present specification, the embedding property is intended to refer to a property of being able to be embedded into a corner portion without leaving any gaps. Furthermore, the composition is also required to be able to maintain the embedded state in the corner portion after being embedded therein.

As a result of studying the composition described in JP1988-036341A (JP-S63-036341A), the present inventors have found that there is room for improvement in terms of the balance between water stopping ability, embedding property, and maintainability of an embedded state.

Therefore, an object of the present invention is to provide a composition that is excellent in water stopping ability, embedding property, and maintainability of an embedded state.

In addition, another object of the present invention is to provide a film formed of the above-mentioned composition.

As a result of extensive studies to achieve the above-mentioned objects, the present inventors have found that the objects can be achieved by the following configurations.
[1] A composition comprising:
a polyurethane formed from a polyol containing a polyoxyalkylene structure and a polyisocyanate; and
particles,
in which the composition has an Asker C hardness of 5 or less,
a ratio of a loss elastic modulus G″ to a storage elastic modulus G′ at a temperature of 25° C., a frequency of 1 Hz, and a strain of 0.1% of 0.400 or more, and
a ratio of the storage elastic modulus G′ at a temperature of 25° C., a frequency of 1 Hz, and a strain of 10% to the storage elastic modulus G′ at a temperature of 25° C., a frequency of 1 Hz, and a strain of 0.1% of less than 0.900.
[2] The composition according to [1], in which an equivalent ratio of isocyanate groups of the polyisocyanate to hydroxyl groups of the polyol is 0.75 to 0.79.
[3] The composition according to [1] or [2], in which a content of the particles is 41% by mass or more with respect to a total mass of the composition.
[4] The composition according to any one of [1] to [3], in which the particles have an average particle diameter of 10 μm or more.
[5] The composition according to any one of [1] to [4], in which the particles have a moisture content of 5% by mass or more.
[6] The composition according to any one of [1] to [5], in which the composition has an Asker C hardness of 0.
[7] The composition according to any one of [1] to [6], in which the composition is used for water stopping.
[8] A film comprising:
a substrate layer; and
a composition layer consisting of the composition according to any one of [1] to [7].
[9] The film according to [8], further comprising: an adhesive layer on a side of the composition layer opposite to a substrate layer side.

According to the present invention, it is possible to provide a composition that is excellent in water stopping ability, embedding property, and maintainability of an embedded state.

In addition, according to the present invention, it is also possible to provide a film formed of the above-mentioned composition.

### DESCRIPTION OF THE PREFERRED EMBODIMENTS

In the present specification, any numerical range expressed using “to” means a range that includes the numerical values written before and after “to” as the lower limit value and the upper limit value, respectively.

In addition, in the present specification, in a case where two or more types of a certain component are present, the “content” of the component means a total content of the two or more types of components.

In any numerical range described in a stepwise manner in the present specification, an upper limit value or a lower limit value described in a certain numerical range may be replaced with an upper limit value or a lower limit value of another numerical range described in a stepwise manner. In addition, in any numerical range described in the present specification, an upper limit value or a lower limit value described in a certain numerical range may be replaced with values shown in the Examples.

In the present specification, a combination of two or more preferred aspects is a more preferred aspect.

In the present specification, the term “(meth)acrylic” is a concept that includes either or both of acrylic and methacrylic, the term “(meth)acrylate” is a concept that includes either or both of acrylate and methacrylate, and the same applies to the terms “(meth)acryloyl” and “(meth)acryloxy”.

In addition, the term “organic group” in the present specification refers to a group containing at least one carbon atom.

In the present specification, a weight-average molecular weight (Mw), a number-average molecular weight (Mn), and a polydispersity (also referred to as “molecular weight distribution”) (Mw/Mn) are defined as values expressed in terms of polystyrene by means of gel permeation chromatography (GPC) measurement (solvent: tetrahydrofuran, flow rate (amount of a sample injected): 10 μL, column: TSK gel Multipore HXL-M (manufactured by Tosoh Corporation), column temperature: 40° C., flow velocity: 1.0 mL/min, and detector: differential refractive index detector) using a GPC apparatus (HLC-8120GPC, manufactured by Tosoh Corporation).

In the present specification, unless otherwise specified, measurements of various physical properties are carried out at 25° C. In addition, in a case of measuring various physical properties, unless otherwise specified, the measurement is carried out after an object to be measured is left in a test environment (25° C. unless otherwise specified) for 12 hours or more.

### [Composition]

Hereinafter, the composition according to an embodiment of the present invention will be described in more detail.

The composition according to the embodiment of the present invention (hereinafter, also simply referred to as “composition”) contains a polyurethane formed from a polyol containing a polyoxyalkylene structure (hereinafter, also referred to as “specific polyol”) and a polyisocyanate (hereinafter, also referred to as “specific polyurethane”), and particles, in which the composition has an Asker C hardness of 5 or less, a ratio of a loss elastic modulus G″ to a storage elastic modulus G′ at a temperature of 25° C., a frequency of 1 Hz, and a strain of 0.1% (G″/G′, tan δ) of 0.400 or more, and a ratio of the storage elastic modulus G′ at a temperature of 25° C., a frequency of 1 Hz, and a strain of 10% (hereinafter, also referred to as “G′10%”) to the storage elastic modulus G′ at a temperature of 25° C., a frequency of 1 Hz, and a strain of 0.1% (hereinafter, also referred to as “G′0.1%”) (G′10%/G′0.1%, hereinafter, also referred to as “G′ ratio”) of less than 0.900.

Although the reason why the composition having the above-mentioned configuration can achieve the objects of the present invention is not entirely clear, the present inventors speculate as follows.

The mechanism by which the effect is obtained is not limited by the following speculation. In other words, even in a case where the effect is obtained by a mechanism other than the one described below, it is still included within the scope of the present invention.

The composition according to the embodiment of the present invention has good water swelling property due to the inclusion of the specific polyurethane, and as a result, can quickly absorb water and swell in a case of being in contact with water, and thus has good water stopping ability. In addition, the composition according to the embodiment of the present invention contains particles, thus giving the composition plastic deformability, and has an Asker C hardness of 5 or less and a tan 8 of 0.400 or more, so the composition can be flexibly deformed during application and has excellent embedding property. In addition, since the composition according to the embodiment of the present invention has a G′ ratio of less than 0.900, the repulsive force is less likely to occur in the composition after application, and the embedded state can be favorably maintained.

Hereinafter, the fact that the composition is more excellent in at least one of water stopping ability, embedding property, or embedding retention property will also be referred to as “the effect of the present invention is more excellent”.

Hereinafter, the components that can be contained in the composition and the properties of the composition will be described in more detail.

### [Specific Polyurethane]

The composition contains a specific polyurethane. The specific polyurethane is a polyurethane formed from a polyol containing a polyoxyalkylene structure (specific polyol) and a polyisocyanate. In other words, the specific polyurethane is a reaction product of the specific polyol and the polyisocyanate.

The equivalent ratio of the isocyanate groups (NCO groups) of the polyisocyanate to the hydroxyl groups (OH groups) of the specific polyol is preferably 0.50 to 1.00, more preferably 0.70 to 0.90, still more preferably 0.75 to 0.80, and particularly preferably 0.75 to 0.79, from the viewpoint that the composition easily satisfies predetermined physical properties.

The specific polyurethane preferably has a crosslinked structure from the viewpoint that dissolution of the composition can be prevented.

The crosslinked structure may be any of a physical crosslink or a chemical crosslink, and is preferably a chemical crosslink from the viewpoint of durability. That is, the specific polyurethane preferably has a three-dimensional crosslinked structure formed by a covalent bond.

### (Specific Polyol)

The specific polyol is a polyhydric alcohol compound containing a polyoxyalkylene structure.

The number of hydroxyl groups contained in the specific polyol is not limited as long as it is 2 or more, and is preferably 3 or more, more preferably 3 or 4, and still more preferably 3.

The molecular weight of the specific polyol is preferably 1000 to 10000, more preferably 2000 to 8000, and still more preferably 3000 to 6000, from the viewpoint that the flexibility of the composition is excellent and the effect of the present invention is more excellent. In a case where the specific polyol has a molecular weight distribution, it is preferable that the number-average molecular weight of the specific polyol satisfies the above-mentioned range.

The polyoxyalkylene structure is a structural moiety represented by —(O-AL)ₙ-.

AL represents an alkylene group. The alkylene group may be linear, branched, or cyclic, and is preferably linear or branched and more preferably linear.

The number of carbon atoms in the alkylene group represented by AL is preferably 1 to 6, more preferably 2 to 4, still more preferably 2 or 3, and particularly preferably 2.

Specific examples of the alkylene group represented by AL include a methylene group, an ethylene group, and a propylene group (specifically, an n-propylene group and a 2-methylethylene group), among which an ethylene group or a 2-methylethylene group is preferable and an ethylene group is more preferable.

n represents the repetition number. The repetition number represented by n may be a number of 2 or more and is, for example, preferably 2 to 300, more preferably 10 to 200, still more preferably 15 to 100, and particularly preferably 20 to 50.

In the polyoxyalkylene structure, AL may be one type or two or more types. In addition, the specific polyol may have only one polyoxyalkylene structure in the molecule or may have two or more polyoxyalkylene structures in the molecule.

In addition, the polyoxyalkylene structure preferably contains an oxyethylene structural unit from the viewpoint that the water swelling property of the specific polyurethane is excellent and the water stopping ability is more excellent.

In the specific polyol, the content of the oxyethylene structural unit in the molecule is preferably 30 mol % or more, more preferably 50 mol % or more, still more preferably 60 mol % or more, particularly preferably 65 mol % or more, and most preferably 70 mol % or more with respect to all the oxyalkylene structural units in the molecule, from the viewpoint that the water swelling property of the specific polyurethane is excellent and the water stopping ability is more excellent. The upper limit value of the content of the oxyethylene structural unit is 100 mol % or less.

The specific polyol is preferably a polyoxyalkylene polyol obtained by polymerizing an oxirane compound containing at least ethylene oxide using a low molecular weight polyol as an initiator.

Examples of the low molecular weight polyol include low molecular weight diols such as ethylene glycol, propylene glycol, 1,4-butanediol, 1,3-butanediol, 1,2-butanediol, and diethylene glycol, and low molecular weight triols such as glycerin and trimethylolpropane, among which low molecular weight triols are preferable.

Examples of the oxirane compound include propylene oxide, butylene oxide, and tetrahydrofuran, in addition to the above-mentioned ethylene oxide.

The specific polyol is preferably a compound represented by Formula (PO1), from the viewpoint that the effect of the present invention is more excellent.

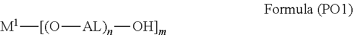

In Formula (PO1), M¹ represents an m-valent linking group. AL represents an alkylene group. n is the repetition number and represents a number of 2 or more. m represents an integer of 2 or more.

The m-valent linking group represented by M¹ is not particularly limited, and examples thereof include an m-valent aliphatic group and an m-valent aromatic group, among which an m-valent aliphatic group is preferable.

Examples of the m-valent aliphatic group include an m-valent aliphatic hydrocarbon group and a group in which one or more carbon atoms of an m-valent aliphatic hydrocarbon group are substituted with a heteroatom, among which an m-valent aliphatic hydrocarbon group is preferable. Examples of the heteroatom include an oxygen atom, a nitrogen atom, and a sulfur atom, among which an oxygen atom is preferable.

The number of carbon atoms in the m-valent linking group is preferably 1 to 20, more preferably 3 to 12, still more preferably 3 to 6, particularly preferably 3 or 4, and most preferably 3.

AL represents an alkylene group. The alkylene group may be linear, branched, or cyclic, and is preferably linear or branched and more preferably linear.

The number of carbon atoms in the alkylene group represented by AL is preferably 1 to 6, more preferably 2 to 4, still more preferably 2 or 3, and particularly preferably 2.

Specific examples of the alkylene group represented by AL include a methylene group, an ethylene group, and a propylene group (specifically, an n-propylene group and a 2-methylethylene group), among which an ethylene group or a 2-methylethylene group is preferable and an ethylene group is more preferable.

AL may be one type or two or more types.

n represents the repetition number. The repetition number represented by n may be a number of 2 or more and is, for example, preferably 2 to 300, more preferably 10 to 200, still more preferably 15 to 100, and particularly preferably 20 to 50.

The structure represented by —(O-AL)n- in Formula (PO1) is also preferably a structure represented by —(O—C₂H₄)n_{A}-(O—C₃H₆)n_{B}-. n_{A} and ng represent the repetition number, and each independently represent a number of 2 or more. The total number of n_{A} and n_{B} is, for example, preferably 2 to 300, more preferably 10 to 200, still more preferably 15 to 100, and particularly preferably 20 to 50.

m represents an integer of 2 or more and is preferably an integer of 2 to 8, more preferably 3 or 4, and still more preferably 3.

In the compound represented by Formula (PO1), the content of the oxyethylene structural unit in the molecule (the structural unit represented by —O—C₂H₄— in the molecule) is preferably 30 mol % or more, more preferably 50 mol % or more, still more preferably 60 mol % or more, particularly preferably 65 mol % or more, and most preferably 70 mol % or more with respect to all the oxyalkylene structural units in the molecule (the total of the oxyalkylene structural units represented by —O-AL- in the molecule), from the viewpoint that the water swelling property of the specific polyurethane is excellent and the water stopping ability is more excellent. The upper limit value of the content of the oxyethylene structural unit is 100 mol % or less.

For example, SANNIX FA-103 (manufactured by Sanyo Chemical Industries, Ltd., a trifunctional polyol which contains a polyoxyalkylene structure and has a content of an oxyethylene structural unit in a molecule of 70 mol % with respect to all the oxyalkylene structural units in the molecule), NEWPOL 80-4000 (manufactured by Sanyo Chemical Industries, Ltd., a difunctional polyol which contains a polyoxyalkylene structure and has a content of an oxyethylene structural unit in a molecule of 80 mol % with respect to all the oxyalkylene structural units in the molecule), NEWPOL PE-64 (manufactured by Sanyo Chemical Industries, Ltd., a difunctional polyol which contains a polyoxyalkylene structure and has a content of an oxyethylene structural unit in a molecule of 40 mol % with respect to all the oxyalkylene structural units in the molecule), and SANNIX FA-195 (manufactured by Sanyo Chemical Industries, Ltd., a trifunctional polyol which contains a polyoxyalkylene structure and has a content of an oxyethylene structural unit in a molecule of 70 mol % with respect to all the oxyalkylene structural units in the molecule can be used as the specific polyol.

The specific polyols may be used alone or in combination of two or more thereof.

The content of the structure derived from the specific polyol in the specific polyurethane is preferably 20% to 45% by mass, more preferably 20% to 40% by mass, and still more preferably 25% to 40% by mass with respect to the total mass of the composition.

### (Polyisocyanate)

The polyisocyanate is a compound having two or more isocyanate groups (NCO groups). The number of isocyanate groups contained in the polyisocyanate is not particularly limited as long as it is 2 or more and is preferably 3 to 6, and more preferably 3.

The molecular weight of the polyisocyanate is preferably 100 to 1000, more preferably 150 to 500, and still more preferably 200 to 300. In a case where the polyisocyanate has a molecular weight distribution, it is preferable that the number-average molecular weight of the polyisocyanate satisfies the above-mentioned range.

Any known polyisocyanate can be used as the polyisocyanate, and examples thereof include a chain-like aliphatic polyisocyanate, an alicyclic polyisocyanate, an aromatic polyisocyanate, and a complex thereof. Examples of the complex include an isocyanurate, a biuret, an allophanate, and an adduct.

Examples of the chain-like aliphatic polyisocyanate include linear aliphatic diisocyanates such as methylene diisocyanate, ethylene diisocyanate, propylene diisocyanate, tetramethylene diisocyanate, pentamethylene diisocyanate, hexamethylene diisocyanate (HDI), heptamethylene diisocyanate, octamethylene diisocyanate, nonamethylene diisocyanate, and decamethylene diisocyanate, and branched aliphatic diisocyanates such as trimethylhexamethylene diisocyanate.

Examples of the alicyclic polyisocyanate include isophorone diisocyanate (IPDI), 4,4-dicyclohexylmethane diisocyanate, 1,4-cyclohexylene diisocyanate, and hydrogenated tolylene diisocyanate.

Examples of the aromatic polyisocyanate include 4,4′-diphenylmethane diisocyanate (MDI), 2,4-tolylene diisocyanate, 2,6-tolylene diisocyanate, 1,5-naphthalene diisocyanate, p- or m-phenylene diisocyanate, xylylene diisocyanate, m-tetramethylxylylene diisocyanate, toluene diisocyanate (TDI), phenylene diisocyanate, toluidine diisocyanate, xylylene diisocyanate, naphthylene diisocyanate, triisocyanate toluene, triisocyanate benzene, dianisidine diisocyanate, 4,4′-diphenyl ether diisocyanate, and 4,4′,4″-triphenylmethane triisocyanate.

The polyisocyanate is preferably a complex of a linear aliphatic diisocyanate or a triisocyanate, and more preferably a complex of HDI.

For example, DURANATE D101, DURANATE D201, DURANATE TKA-100, DURANATE E402-100, DURANATE AE700-100, and DURANATE TUL-100 (all manufactured by Asahi Kasei Corporation) can be used as the polyisocyanate.

The polyisocyanates may be used alone or in combination of two or more thereof.

The content of the structure derived from the polyisocyanate in the specific polyurethane is preferably 1% to 10% by mass, more preferably 1% to 5% by mass, and still more preferably 2% to 4% by mass with respect to the total mass of the composition.

In addition, a mass ratio of the structure derived from the polyisocyanate to the structure derived from the specific polyol in the specific polyurethane is preferably 0.01 to 0.20, more preferably 0.05 to 0.15, and still more preferably 0.05 to 0.11.

The specific polyurethanes may be used alone or in combination of two or more thereof.

The content of the specific polyurethane is preferably 20% to 50% by mass, more preferably 20% to 40% by mass, still more preferably 20% to 35% by mass, and particularly preferably 20% to 32% by mass with respect to the total mass of the composition.

### [Particles]

The composition contains particles. The composition has plastic deformability because the composition contains particles.

The shape of the particles is not particularly limited and examples thereof include a spherical shape, a polygonal shape, a scale shape, a flat plate shape, and an irregular shape.

The average particle diameter of the particles is preferably 1 μm or more, more preferably 5 μm or more, and still more preferably 10 μm or more, from the viewpoint that the composition is more likely to satisfy the predetermined physical properties. The upper limit value of the average particle diameter of the particles is not particularly limited and is, for example, preferably 100 μm or less, and more preferably 50 μm or less.

The average particle diameter of the particles can be obtained by measuring the particle diameters of any 10 particles in a visual field in the scanning electron microscope (SEM) observation of the particles, and calculating an arithmetic average value of the measured values.

In addition, the particles are preferably water-containing particles from the viewpoint that the composition is likely to satisfy the predetermined physical properties. The moisture content of the particles is preferably 1% by mass or more, more preferably 3% by mass or more, still more preferably 5% by mass or more, and particularly preferably 10% by mass or more. The upper limit value of the moisture content of the particles is preferably 15% by mass or less, and more preferably 12% by mass or less.

The moisture content (%) of the particles can be calculated from the change in mass before and after heating in a case where 1 g of the particles is weighed into an aluminum cup and heated in an oven under heating conditions of 105° C. for 4 hours.

In a case where the particles are starch particles, the higher the moisture content, the lower the Asker C hardness of the composition tends to be. The moisture content is preferably 10% by mass or more in a case where the particles are starch particles.

The particles may be any of organic particles or inorganic particles, and organic particles are preferable.

Above all, the organic particles are preferably resin particles, and more preferably polysaccharide particles.

Examples of the polysaccharide particles include starch particles. Examples of the starch particles include corn starch, potato starch, wheat starch, tapioca starch, waxy corn starch, rice starch, and sweet potato starch.

In addition, the starch particles may also be chemically modified. Examples of the modification method for obtaining the modified starch particles include esterification such as an acetylation treatment, etherification such as carboxyalkylation, phosphorylation, oxidation, sulfation, phosphoric acid crosslinking, adipic acid crosslinking, an enzyme treatment, a moisture-heat treatment, and a combination thereof, and among which phosphoric acid crosslinking and/or a moisture-heat treatment is preferable. In addition, the starch particles may be crosslinked. The crosslinking method is not particularly limited and examples thereof include a crosslinking method using a crosslinking agent and a crosslinking method using radiation (for example, radiation such as gamma rays, X-rays, or electron beams) and/or heat.

The particles may be used alone or in combination of two or more thereof.

The lower limit value of the content of the particles is preferably 25% by mass or more, more preferably 30% by mass or more, and still more preferably 41% by mass or more with respect to the total mass of the composition, from the viewpoint that the composition is more likely to satisfy the predetermined physical properties. The upper limit value of the content of the particles is preferably 70% by mass or less, more preferably 60% by mass or less, and still more preferably 55% by mass or less with respect to the total mass of the composition, from the viewpoint that the composition is more likely to satisfy the predetermined physical properties.

Above all, the suitable numerical value range of the content of the particles is preferably 25% to 70% by mass, more preferably 25% to 60% by mass, still more preferably 30% to 55% by mass, and particularly preferably 41% to 55% by mass with respect to the total mass of the composition, from the viewpoint that the composition is more likely to satisfy the predetermined physical properties.

### [Catalyst]

The composition may contain a catalyst (preferably a polyaddition catalyst) for the synthesis of the specific polyurethane.

Any known catalyst can be used as the catalyst. For example, an organic metal compound and a tertiary amine compound can be used. Specifically, for example, an organic tin catalyst such as dibutyltin dilaurate or dibutyltin dioctylate, an organic lead catalyst such as lead octylate, and a tertiary amine compound such as triethylenediamine, N,N′-dimethylhexamethylenediamine, or N,N′-dimethylbutanediamine can be used.

The catalysts may be used alone or in combination of two or more thereof.

The content of the catalyst is preferably 0.01% to 1.0% by mass, and more preferably 0.05% to 0.3% by mass with respect to the total mass of the composition.

### [Plasticizer]

The composition preferably contains a plasticizer, from the viewpoint that the predetermined physical properties of the composition can be easily obtained.

It is also preferable that the plasticizer has no crosslinked structure.

The plasticizer is not particularly limited as long as it is a plasticizer compatible with the specific polyurethane. From the viewpoint that the predetermined physical properties of the composition can be easily obtained, the plasticizer is preferably a polyether ester-based plasticizer.

Examples of the polyether ester-based plasticizer include an organic acid ester of polyalkylene glycol and a compound represented by Formula (PP1).

Examples of the polyalkylene glycol include polyethylene glycol, polypropylene glycol, polybutylene glycol, a poly(ethylene oxide propylene oxide) block copolymer, a poly(ethylene oxide propylene oxide) random copolymer, and polytetramethylene glycol. The polyether chain may contain an aromatic unit such as a bisphenol.

Examples of the organic acid include a monocarboxylic acid (for example, benzoic acid, butanoic acid, isobutanoic acid, 2-ethylbutyric acid, 2-ethylhexanoic acid, or decanoic acid).

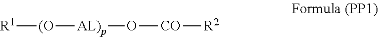

In Formula (PP1), R¹ represents a hydrogen atom or a monovalent organic group. R² represents a monovalent organic group. AL represents an alkylene group. p represents an integer of 2 or more.

Examples of the monovalent organic group represented by R¹ include an alkyl group, an aryl group, an aralkyl group, and an acyl group.

The alkyl group may be linear, branched, or cyclic. The number of carbon atoms in the alkyl group is preferably 1 to 20, more preferably 1 to 18, and still more preferably 1 to 10.

Examples of the aryl group include an aryl group having 6 to 18 carbon atoms. The aryl group may be monocyclic or polycyclic.

Examples of the aralkyl group include the above-mentioned alkyl group in which one of the hydrogen atoms is substituted with the above-mentioned aryl group. The number of carbon atoms in the aralkyl group is preferably 7 to 18. Examples of the aralkyl group include a benzyl group and a phenethyl group.

Examples of the acyl group include an alkylcarbonyl group and an arylcarbonyl group.

The alkyl group moiety of the alkylcarbonyl group may be linear, branched, or cyclic. The number of carbon atoms in the alkylcarbonyl group is preferably 2 to 20, more preferably 2 to 18, and still more preferably 2 to 10.

The aryl group moiety of the arylcarbonyl group may be monocyclic or polycyclic, and examples thereof include an aryl group having 6 to 18 carbon atoms.

Examples of the monovalent organic group represented by R² include an alkyl group, an aryl group, and an aralkyl group. Examples of the alkyl group, aryl group, and aralkyl group include the same alkyl group, aryl group, and aralkyl group as those represented by R¹ described above.

AL represents an alkylene group. The alkylene group may be linear, branched, or cyclic, and is preferably linear or branched and more preferably linear.

The number of carbon atoms in the alkylene group represented by AL is preferably 1 to 6, more preferably 2 to 4, still more preferably 2 or 3, and particularly preferably 2.

Specific examples of the alkylene group represented by AL include a methylene group, an ethylene group, and a propylene group (specifically, an n-propylene group and a 2-methylethylene group), among which an ethylene group or a 2-methylethylene group is preferable and an ethylene group is more preferable.

AL may be one type or two or more types.

p represents the repetition number. The repetition number represented by p may be a number of 2 or more and is, for example, preferably 2 to 50, more preferably 3 to 10, and still more preferably 4 or 5.

Examples of commercially available products of the polyether ester-based plasticizer include SANFLEX EB-200 and SANFLEX EB-400 (manufactured by Sanyo Chemical Industries, Ltd.), and ADK CIZER RS-1000, RS-735, and RS-700 (manufactured by ADEKA Corporation).

The plasticizers may be used alone or in combination of two or more thereof.

The content of the plasticizer is preferably 15% to 40% by mass, more preferably 15% to 35% by mass, and still more preferably 20% to 35% by mass with respect to the total mass of the composition.

### [Other Components]

The composition may contain components other than the above-mentioned components. Examples of the other components include an adhesive component that can be contained in the adhesive layer which will be described later, a resin other than the specific polyurethane, a polymerization initiator, a coloring agent, and a crosslinking agent.

### [Properties of Composition]

### <Asker C Hardness>

The Asker C hardness of the composition is 5 or less. From the viewpoint that the effect of the present invention is more excellent, the Asker C hardness is preferably 3 or less, more preferably 2 or less, and still more preferably 1 or less. The lower limit of the Asker C hardness of the composition is 0.

The Asker C hardness can be measured at a test temperature of 25° C. by a method in accordance with JIS K 7312 using an Asker C type tester (Asker rubber hardness meter C type, manufactured by Kobunshi Keiki Co., Ltd.). The Asker C hardness is measured after the object to be measured is placed in a test environment (25° C.) for 12 hours or more.

### <Viscoelastic Properties>

The tan δ of the composition at a temperature of 25° C., a frequency of 1 Hz, and a strain of 0.1% is 0.400 or more. From the viewpoint that the effect of the present invention is more excellent, the tan 8 of the composition is preferably 0.500 or more, more preferably 0.550 or more, and still more preferably 0.600 or more. The upper limit of the tan 8 of the composition is not particularly limited and is often 1.000 or less, and preferably 0.800 or less.

The tan δ of the composition at a temperature of 25° C., a frequency of 1 Hz, and a strain of 0.1% can be calculated from values of a storage elastic modulus G′and a loss elastic modulus G″ at a strain of 0.1%, which are obtained by carrying out strain dispersion measurement at strains of 0.001% to 100% using a rheometer (MCR302, manufactured by Anton Paar GmbH) at a temperature of 25° C. and a measurement frequency of 1 Hz. The strain dispersion measurement is carried out after the object to be measured is placed in a test environment (25° C.) for 12 hours or more.

The storage elastic modulus G′ of the composition at a temperature of 25° C., a frequency of 1 Hz, and a strain of 0.1% is preferably 500 to 50000 Pa, more preferably 1000 to 30000 Pa, and still more preferably 1000 to 20000 Pa.

The loss elastic modulus G″ of the composition at a temperature of 25° C., a frequency of 1 Hz, and a strain of 0.1% is preferably 500 to 50000 Pa, more preferably 1000 to 30000 Pa, still more preferably 1000 to 20000 Pa, and particularly preferably 1000 to 12000 Pa.

The storage elastic modulus G′ and the loss elastic modulus G″ are determined in the same manner as in the above-mentioned tan 8.

The ratio (G′ ratio) of the storage elastic modulus G′ at a temperature of 25° C., a frequency of 1 Hz, and a strain of 10% to the storage elastic modulus G′ at a temperature of 25° C., a frequency of 1 Hz, and a strain of 0.1% in the composition is less than 0.900. From the viewpoint that the effect of the present invention is more excellent, the G′ ratio is preferably 0.700 or less, and more preferably 0.600 or less. The lower limit of the G′ ratio is not particularly limited and is often 0.100 or more, preferably 0.200 or more, and more preferably 0.400 or more.

The storage elastic modulus G′ at a strain of 0.1% is determined in the same manner as in the above-mentioned tan 8. In addition, the storage elastic modulus G′ at a strain of 10% is determined from the value of the storage elastic modulus G′ at a strain of 10% in the same manner as in the above-mentioned tan 8.

The water absorption rate of the composition is preferably 1.1 to 5.0, more preferably 2.0 to 4.0, and still more preferably 2.0 to 3.0, from the viewpoint of water stopping ability and durability.

The water absorption rate is a water absorption rate after 1 hour, and can be calculated by dividing the mass of the composition immersed in water adjusted to 25° C. for 1 hour by the mass of the composition before the immersion thereof.

### [Manufacturing Method of Composition]

The manufacturing method of the composition is not particularly limited, and the composition can be manufactured by a known method.

The manufacturing method of the composition may be, for example, a method in which raw materials for the specific polyurethane (a specific polyol and a polyisocyanate), particles, a plasticizer, and, as necessary, other optional components (for example, a catalyst and a coloring agent) are mixed together, and a composition is manufactured while polymerizing the specific polyurethane.

The mixing may be carried out in the air or in an inert gas atmosphere. In addition, the mixing may be carried out under normal pressure or under reduced pressure.

In a case of polymerization of the specific polyurethane, a polymerization treatment such as a heating treatment or a light irradiation treatment may be carried out as necessary.

A drying treatment may be carried out as necessary on one or more selected from the raw materials before mixing, the mixture, and the composition after formation.

### [Use]

The use of the composition according to the embodiment of the present invention is not particularly limited, and it is preferable that the composition is used for water stopping. The water stopping method may be used to prevent or reduce water leakage.

The aspect in which the composition is used for water stopping is not particularly limited, and the composition may be directly disposed at a water stopping location or may be used in an aspect of a film which will be described later.

In addition, the composition according to the embodiment of the present invention can also be used as a water-retaining material for agriculture. For example, it is possible to reduce the frequency of watering the crops by directly spraying the composition to a field or covering the soil with a film which will be described later.

### [Film]

The film according to the embodiment of the present invention includes a substrate layer and a composition layer which is a layer of the above-mentioned composition.

### [Substrate Layer]

The material for the substrate constituting the substrate layer is not particularly limited, and examples thereof include a resin.

Examples of the resin include cellulose, polyester, rayon, polyolefin, poly(meth)acrylate, polyethylene terephthalate (PET), polyethylene naphthalate (PEN), polycarbonate (PC), a cycloolefin polymer (COP), and an acrylonitrile/butadiene/styrene copolymer (ABS).

From the viewpoint of workability, the substrate preferably has flexibility.

The substrate may contain fibers. Examples of the fibers include cellulose fibers, rayon fibers, polyolefin fibers, and polyester fibers. The substrate containing fibers is preferably a nonwoven fabric, a fabric, or paper, and more preferably a nonwoven fabric.

The thickness of the substrate layer is not particularly limited and is, for example, 15 to 200 μm.

The substrate may have a function as an adhesive layer having pressure sensitive adhesiveness or adhesiveness.

### [Composition Layer]

The film includes a composition layer which is a layer of the above-mentioned composition.

The method for forming the composition layer is not particularly limited, and examples thereof include a method of bonding a composition onto a substrate and a method of applying a composition for forming a composition layer onto a substrate to form a composition layer.

The composition for forming a composition layer is not particularly limited, and examples thereof include a composition containing raw materials for a specific polyurethane (a specific polyol and a polyisocyanate), particles, a plasticizer, and, as necessary, other optional components (for example, a catalyst and a coloring agent). After the composition for forming a composition layer is disposed on the substrate, a polymerization treatment (for example, a heating treatment or a light irradiation treatment) may be carried out as necessary.

The thickness of the composition layer is preferably 100 to 5000 μm, and more preferably 1000 to 2000 μm.

### [Adhesive Layer]

The film preferably further has an adhesive layer on a side of the composition layer opposite to the substrate layer side.

The adhesive layer is a layer having at least one function of adhesion or pressure sensitive adhesion to a member (for example, glass, a resin, a metal, or ceramics). Providing the film with an adhesive layer makes it possible to easily maintain the film at the water stopping location.

The adhesive layer is preferably a water-absorbing adhesive layer. The water-absorbing adhesive layer is a layer that absorbs water in a case of being brought into contact with water, and thereby exhibits or increases adhesiveness or pressure sensitive adhesiveness. In a case where the adhesive layer is a water-absorbing adhesive layer, excellent adhesiveness can be exhibited even in a water-wetted location, and convenience in a case where the film is used as a water stopping film is excellent.

As the component of the adhesive layer, it is possible to use a known adhesive and a known pressure sensitive adhesive, examples of which include a vinyl resin, silicone, poly(meth)acrylate, polyurethane, polyamide, polyester, polyolefin, and rubber.

Examples of the vinyl resin include polyvinyl alcohol and polyvinylpyrrolidone.

Examples of the silicone include addition reaction type silicone, peroxide-cured type silicone, and condensation type silicone.

Examples of the poly(meth)acrylate include a homopolymer of a (meth)acrylic acid ester monomer and a copolymer of a (meth)acrylic acid ester monomer with other monomers. Examples of the (meth)acrylic acid ester monomer include methyl (meth)acrylate, ethyl (meth)acrylate, butyl (meth)acrylate, 2-ethylhexyl (meth)acrylate, hydroxyethyl methacrylate, hydroxypropyl methacrylate, dimethylaminoethyl methacrylate, and glycidyl methacrylate. Examples of the other monomers include vinyl acetate, (meth)acrylonitrile, (meth)acrylamide, styrene, methacrylic acid, acrylic acid, itaconic acid, methylol acrylamide, and a maleic acid anhydride.

Examples of the polyurethane include polyester polyurethane and polycarbonate polyurethane.

Examples of the polyamide include polyamide (amide 11) obtained by ring-opening polycondensation of undecane lactam and polyamide (amide 12) obtained by ring-opening polycondensation of lauryl lactam.

Examples of the polyester include a polycondensate of a polyvalent carboxylic acid with a polyhydric alcohol, specific examples of which include polyethylene terephthalate and polybutylene terephthalate.

Examples of the polyolefin include a homopolymer of an olefin and a copolymer of an olefin with other monomers. The olefin is preferably an olefin having 2 to 6 carbon atoms. Examples of the olefin include ethylene, propylene, butene, methylpentene, and hexene. Examples of the copolymer of an olefin with other monomers include an ethylene-vinyl acetate copolymer (EVA), an ethylene-acrylic acid copolymer (EAA), an ethylene-ethyl acrylate copolymer (EEA), and an ethylene-methyl methacrylate copolymer (EMMA).

Examples of the rubber include a styrene/butadiene copolymer (SBR or SBS), a styrene/isoprene copolymer (SIS), an acrylonitrile-butadiene copolymer (NBR), a chloroprene polymer, and an isobutylene/isoprene copolymer (butyl rubber).

From the viewpoint of excellent water-absorbing adhesiveness, the adhesive layer preferably contains a vinyl resin, and more preferably contains a polyvinyl alcohol.

The method for forming the adhesive layer is not particularly limited, and for example, the adhesive layer can be formed by applying a composition for forming an adhesive layer onto the composition layer. After the composition for forming an adhesive layer is applied, a drying treatment and a heating treatment may be carried out as necessary.

The composition for forming an adhesive layer may contain other components in addition to those described above. Examples of the other components include a solvent, an ultraviolet absorber, an antioxidant, a crosslinking agent, a surfactant, a filler, a colorant, a light stabilizer, a thickener, and a polymerization initiator.

The thickness of the adhesive layer is, for example, 10 to 500 μm.

The film is preferably used as a water stopping film. In addition, the film having an adhesive layer may be used as a water stopping tape.

The method of using the film is not particularly limited, and examples thereof include a method of disposing the film on an object such that the object and the composition layer side of the film face each other. The object is not particularly limited, and examples thereof include a building, more specifically, a location including a gap such as a window or a door. In a case where the film is disposed at the location where a gap exists, the composition that comes into contact with the water that has entered through the gap swells to block the gap, which can lead to water stopping.

### EXAMPLES

Hereinafter, the present invention will be described in more detail with reference to Examples. The materials, the used amount, the ratio, the contents of a treatment, the procedures of a treatment, and the like shown in Examples below may be appropriately modified without departing from the spirit of the present invention. Therefore, the scope of the present invention should not be construed as being limited to Examples given below.

### Example 1

### [Preparation of Composition and Production of Film]

The components shown in Table 1 were mixed in a 300 mL stirring container (product name “002 stirring container”, manufactured by Kinki Yoki Co., Ltd.) to have the composition shown in Table 1, thereby obtaining 100 g of a mixture.

The mixture was placed in a mixer (product name “ARV-310”, manufactured by Thinky Corporation) and subjected to a stirring treatment under reduced pressure for 1 minute under conditions of a rotation speed of 900 revolutions per minute (rpm) and a pressure of 3 kPa.

18 g of the mixture after the stirring treatment under reduced pressure was poured into a flat glass petri dish (inner diameter: 7 cmφ) and allowed to stand at 25° C. for 24 hours. Thereafter, the composition was taken out from the flat glass petri dish to obtain a cylindrical composition sample A having a diameter of about 7 cm and a height of about 4 mm.

Separately, the mixture after the stirring treatment under reduced pressure was poured into a container made of an acrylic resin and having a length of 50 mm, a width of 100 mm, and a height of 2 mm, and allowed to stand at 25° C. for 2 hours. After that, a nonwoven fabric (substrate, KURASEAL M) cut into a length of 50 mm and a width of 100 mm was bonded onto the mixture which was then allowed to stand at 25° C. for 22 hours or more. Thereafter, the laminate having the composition layer on the substrate layer was taken out from the container made of an acrylic resin, and a PVA film (SOLVRON PT40, manufactured by Aicello Corporation) cut into a length of about 50 mm and a width of about 100 mm was bonded to a surface of the composition layer opposite to the substrate, thereby obtaining a film sample B having a length of about 50 mm, a width of about 100 mm, and a height of about 2 mm, and having a substrate layer, a composition layer, and an adhesive layer in this order.

### [Measurement of Physical Properties]

### <Measurement of Asker C Hardness>

The produced composition sample A was measured for Asker C hardness at 25° C. using an Asker rubber hardness meter C type (manufactured by Kobunshi Keiki Co., Ltd.). The measurement of the Asker C hardness was carried out after the produced composition sample A was left in a test environment of 25° C. for 12 hours or more.

### <Measurement of Storage Elastic Modulus G′, Loss Elastic Modulus G″, and Tan δ>

For the produced composition sample A, a strain dispersion measurement at strains of 0.001% to 100% was carried out using a rheometer (MCR302, manufactured by Anton Paar GmbH) under conditions of a temperature of 25° C., a frequency of 1 Hz, Nf=1 N, and a measurement plate of PP25. The tan 8 at a temperature of 25° C., a frequency of 1 Hz, and a strain of 0.1% was calculated from the obtained values of the storage elastic modulus G′ and the loss elastic modulus G″ at a strain of 0.1%. The strain dispersion measurement was carried out after the produced composition sample A was left in a test environment of 25° C. for 12 hours or more.

### <Measurement of G′ Ratio>

For the produced composition sample A, a strain dispersion measurement at strains of 0.001% to 100% was carried out using a rheometer (MCR302, manufactured by Anton Paar GmbH) under conditions of a temperature of 25° C., a frequency of 1 Hz, Nf=1 N, and a measurement plate of PP25. The strain dispersion measurement was carried out after the produced composition sample A was left in a test environment of 25° C. for 12 hours or more. The G′ ratio (storage elastic modulus G′ at a strain of 10%/storage elastic modulus G′ at a strain of 0.1%) at a temperature of 25° C. and a frequency of 1 Hz was calculated from the obtained values of the storage elastic modulus G′ at a strain of 0.1% and the storage elastic modulus G′ at a strain of 10%.

### Examples 2 to 4, 7, and 8, and Comparative Examples 1 to 7

The preparation of a composition, the production of a film, and the measurement of physical properties were carried out in the same manner as in Example 1, except that the composition and the formulation amount were adjusted as shown in Table 1.

### Example 5

The preparation of a composition, the production of a film, and the measurement of physical properties were carried out in the same manner as in Example 1, except that, in the production of the film sample B, the step of bonding a PVA film (SOLVRON PT40, manufactured by Aicello Corporation) to a surface of the composition layer opposite to the substrate was not carried out.

### Example 6

The preparation of a composition, the production of a film, and the measurement of physical properties were carried out in the same manner as in Example 1, except that, in the production of the film sample B, the step of bonding a nonwoven fabric (substrate, KURASEAL M) onto the mixture was not carried out.

### [Various Components]

Hereinafter, each of the components shown in Table 1 will be described.

### [Polyol]

“EXCENOL 840” (manufactured by AGC Inc., a trifunctional polyol which contains a polyoxyalkylene structure and has a content of an oxyethylene structural unit in a molecule of 15 mol % with respect to all the oxyalkylene structural units in the molecule).
“SANNIX FA-103” (manufactured by Sanyo Chemical Industries, Ltd., a trifunctional polyol which contains a polyoxyalkylene structure and has a content of an oxyethylene structural unit in a molecule of 70 mol % with respect to all the oxyalkylene structural units in the molecule)

### [Polyisocyanate]

“DURANATE TKA-100” (manufactured by Asahi Kasei Corporation, a trifunctional polyisocyanate)

### [Plasticizer]

“SANFLEX EB-200” (manufactured by Sanyo Chemical Industries, Ltd., a plasticizer having a polyoxyethylene structure)
Diisononyl phthalate (manufactured by FUJIFILM Wako Pure Chemical Corporation)

### [Catalyst]

Dibutyltin dilaurate (manufactured by FUJIFILM Wako Pure Chemical Corporation)

### [Particles]

Corn starch (manufactured by FUJIFILM Wako Pure Chemical Corporation, corn starch, average particle diameter: 15 μm, moisture content: 12% by mass)
FINE SNOW (manufactured by Joetsu Starch Co., Ltd., rice starch, average particle diameter: 5 μm, moisture content: 10% by mass)
Calcium carbonate (manufactured by FUJIFILM Wako Pure Chemical Corporation, average particle diameter: 4 μm, moisture content: 0% by mass)

### <Measurement of Particle Diameter of Particles>

The particles were observed under a SEM, and the particle diameters of any 10 particles in the visual field were measured. The arithmetic average value of the obtained measurement values was calculated and defined as the average particle diameter.

### <Measurement of Moisture Content of Particles>

1 g of the particles was weighed into an aluminum cup and heated under the conditions of a temperature of 105° C. for 4 hours using an oven, and the moisture content (%) was calculated from the change in mass before and after heating. Specifically, the moisture content was calculated in accordance with the following expression.

Moisture content(%)=(mass of particles before heating−mass of particles after heating)/mass of particles before heating

### [Evaluation]

### [Water Stopping Ability]

A composition sample C having a length of 60 mm, a width of 60 mm, and a film thickness of 2 mm was prepared in accordance with the production procedure of the sample A. The composition sample C was immersed in distilled water adjusted to 25° C., the mass before immersion and the mass after immersion for 1 hour were measured, and the water absorption rate was calculated in accordance with the following expression.

Water absorption rate=mass of composition sample C after immersion for 1 hour/mass of composition sample C before immersion

From the obtained water absorption rate, the water stopping ability was evaluated in accordance with the following evaluation standards. The faster the water absorption rate, the more quickly the composition swells and the more excellent the water stopping ability. For practical purposes, a rating of B or higher is preferred for the water stopping ability.

### <Evaluation Standards>

A: The water absorption rate is 2.0 or more
B: The water absorption rate is 1.1 or more and less than 2.0
C: The water absorption rate is less than 1.1

### [Embedding Property]

A test water tank made of an acrylic resin and having a width of 300 mm, a depth of 300 mm, a height of 700 mm, and an angle of 90° between a wall surface and a bottom surface was prepared. A through-hole having a width of 50 mm and a height of 10 mm was provided in the lower part of the interior wall of one wall surface of the test water tank at a position in contact with the inner bottom surface.

The film sample B, which was immersed in water for 1 second to be wet with water, was bonded to the interior wall and the inner bottom surface of the test water tank in a direction in which the longitudinal direction (the 100 mm length direction) of the film sample B was substantially parallel to the width direction (the 50 mm direction) of the hole such that the film sample B covered the entire surface of the hole. In this case, the surface of the film sample B taken out from the container made of an acrylic resin was bonded to face the interior wall of the test water tank.

The intersection portion between the interior wall and the inner bottom surface of the test water tank was visually inspected, and the embedding property was evaluated in accordance with the following evaluation standards from the presence or absence of a gap between the test water tank and the film sample B and the extent of the gap. For practical purposes, a rating of B or higher is preferred for the embedding property.

### <Evaluation Standards>

A: No gap occurs between the test water tank and the film.
B: A gap of less than 1 mm occurs between the test water tank and the film.
C: A gap of 1 mm or more occurs between the test water tank and the film.

### [Embedding Retention Property]

After the above-mentioned evaluation of the embedding property was carried out, the gap was checked again after 1 hour, the maintenance of the gap was visually checked, and the embedding retention property was evaluated in accordance with the following standards. For practical purposes, a rating of B or higher is preferred for the embedding retention property.

### <Evaluation Standards>

A: No gap occurs between the test water tank and the film.
B: A gap of less than 1 mm occurs between the test water tank and the film.
C: A gap of 1 mm or more occurs between the test water tank and the film.

### [Wet Surface Workability]

A test water tank made of an acrylic resin and having a width of 300 mm, a depth of 300 mm, a height of 700 mm, and an angle of 90° between a wall surface and a bottom surface was prepared. After the water tank was filled with water, the film sample B was bonded to the inner surface of the water tank in water, and the wet surface workability was evaluated in accordance with the following evaluation standards. From the viewpoint of handling, the film preferably has wet surface workability.
A: Bonding is possible
B: Bonding is not possible

### [Tackiness]

The surface of the film sample B on the substrate side was evaluated for tactile sensation, and the tackiness was evaluated in accordance with the following evaluation standards. In a case where the film sample had no substrate, the surface of the composition layer opposite to the adhesive layer was defined as the surface on the substrate side. From the viewpoint of handling, it is preferable that the surface of the film on the substrate side has no tackiness.
A: There is no tackiness
B: There is tackiness

### [Results]

Table 1 below shows the composition, physical properties, and evaluation results of the composition.

In Table 1, “G′ (Pa)” represents the storage elastic modulus G′ (Pa) at a temperature of 25° C., a frequency of 1 Hz, and a strain of 0.1%, “G” (Pa)” represents the loss elastic modulus G″ (Pa) at a temperature of 25° C., a frequency of 1 Hz, and a strain of 0.1%, and “tan δ (G″/G′)” represents the ratio (tan δ) of the loss elastic modulus G″ to the storage elastic modulus G′ at a temperature of 25° C., a frequency of 1 Hz, and a strain of 0.1%.

In Table 1, “G′ ratio (G′10%/G′0.1%)” represents the ratio of the storage elastic modulus G′ at a temperature of 25° C., a frequency of 1 Hz, and a strain of 10% to the storage elastic modulus G′ at a temperature of 25° C., a frequency of 1 Hz, and a strain of 0.1%.

In Table 1, “NCO/OH” indicates the equivalent ratio of isocyanate groups (NCO) of the polyisocyanate to hydroxyl groups (OH) of the polyol.

In Table 1, the value described in the column of each of the components is the content (parts by mass) in the composition.

TABLE 1

| | | | | Example 1 | Example 2 | Example 3 | Example 4 |
|---|---|---|---|---|---|---|---|
| Composition | Binder | Polyol | EXCENOL 840 | — | — | — | — |
| | | | (content of oxyethylene | | | | |
| | | | structural unit in molecule | | | | |
| | | | with respect to all | | | | |
| | | | oxyalkylene structural units | | | | |
| | | | in molecule: 15 mol %) | | | | |
| | | | SANNIX FA-103 | 34.86 | 29.88 | 27.39 | 24.90 |
| | | | (content of oxyethylene | | | | |
| | | | structural unit in molecule | | | | |
| | | | with respect to all | | | | |
| | | | oxyalkylene structural units | | | | |
| | | | in molecule: 70 mol %) | | | | |
| | | Polyisocyanate | DURANATE TKA-100 | 3.92 | 3.36 | 3.08 | 2.80 |
| | | Plasticizer | SANFLEX EB-200 | 31.08 | 26.64 | 24.42 | 22.20 |
| | | | Diisononyl phthalate | — | — | — | — |
| | | Catalyst | Dibutyltin dilaurate | 0.14 | 0.12 | 0.11 | 0.10 |
| | Particles | Corn starch (average particle diameter: 15 | | 30.00 | 40.00 | 45.00 | 50.00 |
| | | μm, moisture content: 12% by mass) | | | | | |
| | | FINE SNOW (average particle diameter: 5 | | — | — | — | — |
| | | μm, moisture content: 10% by mass) | | | | | |
| | | Calcium carbonate (average particle diameter: | | — | — | — | — |
| | | 4 μm, moisture content: 0% by mass) | | | | | |
| | Total | | | 100 | 100 | 100 | 100 |
| | NCO/OH | | | 0.78 | 0.78 | 0.78 | 0.78 |
| Configuration | Adhesive layer | | | PVA | PVA | PVA | PVA |
| of film | Substrate layer | | | KURASEAL | KURASEAL | KURASEAL | KURASEAL |
| Physical | Asker C hardness | | | 0 | 0 | 0 | 0 |
| properties | G′ (Pa) | | | 2862 | 3820 | 6314 | 15040 |
| | G″ (Pa) | | | 1657 | 2586 | 4382 | 8362 |
| | tan δ (G″/G′) | | | 0.579 | 0.677 | 0.694 | 0.556 |
| | G′ ratio (G′10%/G′0.1%) | | | 0.863 | 0.756 | 0.589 | 0.468 |
| Evaluation | Water | Water absorption rate (−fold/1 h) | | A | A | A | A |
| | stopping | | | | | | |
| | ability | | | | | | |

| | | | | | |
|---|---|---|---|---|---|
| Workability | Embedding property | A | A | A | A |
| | Embedding retention property | B | B | A | A |
| | Wet surface workability | A | A | A | A |
| | Stickiness of back surface | A | A | A | A |

| | | | | Example 5 | Example 6 | Example 7 | Example 8 |
|---|---|---|---|---|---|---|---|
| Composition | Binder | Polyol | EXCENOL 840 | — | — | — | — |
| | | | (content of oxyethylene | | | | |
| | | | structural unit in molecule | | | | |
| | | | with respect to all | | | | |
| | | | oxyalkylene structural units | | | | |
| | | | in molecule: 15 mol %) | | | | |
| | | | SANNIX FA-103 | 27.39 | 27.39 | 29.88 | 29.88 |
| | | | (content of oxyethylene | | | | |
| | | | structural unit in molecule | | | | |
| | | | with respect to all | | | | |
| | | | oxyalkylene structural units | | | | |
| | | | in molecule: 70 mol %) | | | | |
| | | Polyisocyanate | DURANATE TKA-100 | 3.08 | 3.08 | 3.36 | 3.45 |
| | | Plasticizer | SANFLEX EB-200 | 24.42 | 24.42 | 26.64 | 26.55 |
| | | | Diisononyl phthalate | — | — | — | — |
| | | Catalyst | Dibutyltin dilaurate | 0.11 | 0.11 | 0.12 | 0.12 |
| | Particles | Corn starch (average particle diameter: 15 | | 45.00 | 45.00 | — | 40.00 |
| | | μm, moisture content: 12% by mass) | | | | | |
| | | FINE SNOW (average particle diameter: 5 | | — | — | 40.00 | — |
| | | μm, moisture content: 10% by mass) | | | | | |
| | | Calcium carbonate (average particle diameter: | | — | — | — | — |
| | | 4 μm, moisture content: 0% by mass) | | | | | |
| | Total | | | 100 | 100 | 100 | 100 |
| | NCO/OH | | | 0.78 | 0.78 | 0.78 | 0.80 |
| Configuration | Adhesive layer | | | — | PVA | PVA | PVA |
| of film | Substrate layer | | | KURASEAL | — | KURASEAL | KURASEAL |
| Physical | Asker C hardness | | | 0 | 0 | 2 | 0 |
| properties | G′ (Pa) | | | 6314 | 6314 | 15020 | 6564 |
| | G″ (Pa) | | | 4382 | 4382 | 9718 | 2901 |
| | tan δ (G″/G′) | | | 0.694 | 0.694 | 0.647 | 0.442 |
| | G′ ratio (G′10%/G′0.1%) | | | 0.589 | 0.589 | 0.360 | 0.787 |
| Evaluation | Water | Water absorption rate (−fold/1 h) | | A | A | A | A |
| | stopping | | | | | | |
| | ability | | | | | | |

| | | | | | |
|---|---|---|---|---|---|
| Workability | Embedding property | A | A | B | B |
| | Embedding retention property | A | A | B | B |
| | Wet surface workability | B | A | A | A |
| | Stickiness of back surface | A | B | A | A |

TABLE 2

| | | | | Comparative | Comparative | Comparative | Comparative |
|---|---|---|---|---|---|---|---|
| | | | | Example 1 | Example 2 | Example 3 | Example 4 |
| Composition | Binder | Polyol | EXCENOL 840 | — | 49.80 | — | — |
| | | | (content of oxyethylene | | | | |
| | | | structural unit in molecule | | | | |
| | | | with respect to all | | | | |
| | | | oxyalkylene structural units | | | | |
| | | | in molecule: 15 mol %) | | | | |
| | | | SANNIX FA-103 | 49.80 | — | 44.82 | 39.84 |
| | | | (content of oxyethylene | | | | |
| | | | structural unit in molecule | | | | |
| | | | with respect to all | | | | |
| | | | oxyalkylene structural units | | | | |
| | | | in molecule: 70 mol %) | | | | |
| | | Polyisocyanate | DURANATE TKA-100 | 5.60 | 2.10 | 5.04 | 4.48 |
| | | Plasticizer | SANFLEX EB-200 | 44.40 | — | 39.96 | 35.52 |
| | | | Diisononyl phthalate | — | 47.90 | — | — |
| | | Catalyst | Dibutyltin dilaurate | 0.20 | 0.20 | 0.18 | 0.16 |

| | Particles | Corn starch (average particle diameter: 15 | — | — | 10.00 | 20.00 |
|---|---|---|---|---|---|---|
| | | μm, moisture content: 12% by mass) | | | | |
| | | FINE SNOW (average particle diameter: 5 | — | — | — | — |
| | | μm, moisture content: 10% by mass) | | | | |
| | | Calcium carbonate (average particle diameter: | — | — | — | — |
| | | 4 μm, moisture content: 0% by mass) | | | | |
| | Total | | 100 | 100 | 100 | 100 |
| | NCO/OH | | 0.78 | 0.47 | 0.78 | 0.78 |
| Configuration | Adhesive layer | | PVA | PVA | PVA | PVA |
| of film | Substrate layer | | KURASEAL | KURASEAL | KURASEAL | KURASEAL |
| Physical | Asker C hardness | | 4 | 0 | 0 | 0 |
| properties | G′ (Pa) | | 13612 | 7455 | 4116 | 3011 |
| | G″ (Pa) | | 1429 | 924 | 1111 | 1228 |
| | tan δ (G″/G′) | | 0.105 | 0.124 | 0.270 | 0.408 |
| | G′ ratio (G′10%/G′0.1%) | | 1.002 | 0.999 | 0.992 | 0.965 |
| Evaluation | Water | Water absorption rate (−fold/1 h) | A | C | A | A |
| | stopping | | | | | |
| | ability | | | | | |
| | Workability | Embedding property | C | C | C | B |
| | | Embedding retention property | C | C | C | C |
| | | Wet surface workability | A | A | A | A |
| | | Stickiness of back surface | A | A | A | A |

| | | | | Comparative | Comparative | Comparative |
|---|---|---|---|---|---|---|
| | | | | Example 5 | Example 6 | Example 7 |
| Composition | Binder | Polyol | EXCENOL 840 | — | — | — |
| | | | (content of oxyethylene | | | |
| | | | structural unit in molecule | | | |
| | | | with respect to all | | | |
| | | | oxyalkylene structural units | | | |
| | | | in molecule: 15 mol %) | | | |
| | | | SANNIX FA-103 | 49.26 | 89.57 | 27.39 |
| | | | (content of oxyethylene | | | |
| | | | structural unit in molecule | | | |
| | | | with respect to all | | | |
| | | | oxyalkylene structural units | | | |
| | | | in molecule: 70 mol %) | | | |
| | | Polyisocyanate | DURANATE TKA-100 | 5.54 | 10.07 | 3.08 |
| | | Plasticizer | SANFLEX EB-200 | — | — | 24.42 |
| | | | Diisononyl phthalate | — | — | |
| | | Catalyst | Dibutyltin dilaurate | 0.20 | 0.36 | 0.11 |

| | Particles | Corn starch (average particle diameter: 15 | 45.00 | — | — |
|---|---|---|---|---|---|
| | | μm, moisture content: 12% by mass) | | | |
| | | FINE SNOW (average particle diameter: 5 | — | — | — |
| | | μm, moisture content: 10% by mass) | | | |
| | | Calcium carbonate (average particle diameter: | — | — | 45.00 |
| | | 4 μm, moisture content: 0% by mass) | | | |
| | Total | | 100 | 100 | 100 |
| | NCO/OH | | 0.78 | 0.78 | 0.78 |
| Configuration | Adhesive layer | | PVA | PVA | PVA |
| of film | Substrate layer | | KURASEAL | KURASEAL | KURASEAL |
| Physical | Asker C hardness | | 62 | 66 | 21 |
| properties | G′ (Pa) | | 241880 | 516360 | 29804 |
| | G″ (Pa) | | 27816 | 50603 | 7153 |
| | tan δ (G″/G′) | | 0.115 | 0.098 | 0.240 |
| | G′ ratio (G′10%/G′0.1%) | | 0.622 | 0.491 | 0.601 |
| Evaluation | Water | Water absorption rate (−fold/1 h) | A | A | A |
| | stopping | | | | |
| | ability | | | | |
| | Workability | Embedding property | C | C | C |
| | | Embedding retention property | C | C | C |
| | | Wet surface workability | A | A | A |
| | | Stickiness of back surface | A | A | A |

From Table 1, it was confirmed that the composition according to the embodiment of the present invention is excellent in water stopping ability, embedding property, and embedding retention property.

In addition, from the comparison of Examples 1 and 2 with Examples 3 and 4, it was confirmed that the embedding retention property is more excellent in a case where the content of the particles is 41% by mass or more with respect to the total mass of the composition.

In addition, from the comparison of Example 2 with Example 7, it was confirmed that the embedding property is more excellent in a case where the average particle diameter of the particles is 10 μm or more.

In addition, from the comparison of Example 2 with Example 8, it was confirmed that the embedding property is more excellent in a case where the equivalent ratio (NCO/OH) of the isocyanate to the polyol is 0.75 to 0.79.

In addition, from the comparison of Example 3 with Example 5, it was confirmed that the wet surface workability is more excellent in a case where the film has an adhesive layer.

In addition, from the comparison of Example 3 with Example 6, it was confirmed that the stickiness of the back surface is further suppressed in a case where the film has a substrate.

What is claimed is:

1. A composition comprising:
a polyurethane formed from a polyol containing a polyoxyalkylene structure and a polyisocyanate; and
particles,
wherein the composition has an Asker C hardness of 5 or less,
a ratio of a loss elastic modulus G″ to a storage elastic modulus G′ at a temperature of 25° C., a frequency of 1 Hz, and a strain of 0.1% of 0.400 or more, and
a ratio of the storage elastic modulus G′ at a temperature of 25° C., a frequency of 1 Hz, and a strain of 10% to the storage elastic modulus G′ at a temperature of 25° C., a frequency of 1 Hz, and a strain of 0.1% of less than 0.900.

2. The composition according to claim 1,
wherein an equivalent ratio of isocyanate groups of the polyisocyanate to hydroxyl groups of the polyol is 0.75 to 0.79.

3. The composition according to claim 1,
wherein a content of the particles is 41% by mass or more with respect to a total mass of the composition.

4. The composition according to claim 1,
wherein the particles have an average particle diameter of 10 μm or more.

5. The composition according to claim 1,
wherein the particles have a moisture content of 5% by mass or more.

6. The composition according to claim 1,
wherein the composition has an Asker C hardness of 0.

7. The composition according to claim 1,
wherein the composition is used for water stopping.

8. A film comprising:
a substrate layer; and
a composition layer consisting of the composition according to claim 1.

9. The film according to claim 8, further comprising:
an adhesive layer on a side of the composition layer opposite to a substrate layer side.

10. The composition according to claim 2,
wherein a content of the particles is 41% by mass or more with respect to a total mass of the composition.

11. The composition according to claim 2,
wherein the particles have an average particle diameter of 10 μm or more.

12. The composition according to claim 2,
wherein the particles have a moisture content of 5% by mass or more.

13. The composition according to claim 2,
wherein the composition has an Asker C hardness of 0.

14. The composition according to claim 2,
wherein the composition is used for water stopping.

15. A film comprising:
a substrate layer; and
a composition layer consisting of the composition according to claim 2.

16. The film according to claim 15, further comprising:
an adhesive layer on a side of the composition layer opposite to a substrate layer side.

17. The composition according to claim 3,
wherein the particles have an average particle diameter of 10 μm or more.

18. The composition according to claim 3,
wherein the particles have a moisture content of 5% by mass or more.

19. The composition according to claim 3,
wherein the composition has an Asker C hardness of 0.

20. The composition according to claim 3,
wherein the composition is used for water stopping.
